(19) United States
(12) Patent Application Publication
(10) Pub. No.: US 2005/0001208 A1
(43) Pub. Date: Jan. 6, 2005

(54) Hoist method and apparatus

(76) Inventor: Winston Delano Lee, Provo, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 10/833,937

(22) Filed: Apr. 28, 2004

Related U.S. Application Data
(60) Provisional application No. 60/466,287, filed on Apr. 29, 2003.

(51) Int. Cl. B66F 1/00

(52) U.S. Cl. 254/1

(57) ABSTRACT

The present invention features a hoist comprising a primary extension having a circular arrangement and that is helical in shape, or that is formed in the shape of a helix having several coils or laterals. The hoist further comprises a series of supports that comprise a pre-determined length and that dictates the height or extension distance to which the primary extension can extend. The supports are also comprised of a helical shape to allow the laterals of the primary extension to travel thereon once being formed together. Essentially, the primary extension is caused to extend and collapse by rotating the supports in the appropriate direction.

### RELATED APPLICATIONS

This application claims priority to provisional patent application 60/466,287; filed Apr. 29, 2003.

### BACKGROUND

1. Field of the Invention

The present invention relates to hoists, as well as to methods, devices, systems, and apparatus' for hoisting various objects or persons into the air and supporting them, such as a lift. The present invention also relates to methods and devices that function as the means for allowing one to reach elevated positions, such as with a lift or a ladder.

2. Background of the Invention and Related Art

Many prior art hoists and extension devices used to lift and support various items or persons exist in the market. For example, hydraulic lifts are common for lifting items and objects to heights too dangerous for ladders, or that require additional strength to support the item or person. Scissor lifts are also common in the art. However, each of these, and others not mentioned, are limited by the fact that their potential for extension is limited. Moreover, they tend to be bulky and difficult to maneuver.

### SUMMARY AND OBJECTS OF THE INVENTION

In light of the deficiencies discussed above, what is needed is a hoist and method of hoisting that overcomes these deficiencies and improves upon and advances the prior art.

In accordance with the invention as embodied and broadly described herein, the present invention features a hoist comprising a primary extension having a circular arrangement and that is helical in shape, or that is formed in the shape of a helix having several coils or laterals. The primary extension, since it is a helix, comprises a plurality of laterals that are essentially the helical coils making up the rungs of the primary extension. The overall circular design of the hoist makes it easy to manipulate as it can simply be rolled along the ground or floor area into its proper position in anticipation of being actuated. The hoist further comprises a series of supports that comprise a pre-determined length and that dictates the height or extension distance to which the primary extension can extend. The supports may be of any length, but preferably comprise a length at least as long as the primary extension when in a collapsed position. The supports are also comprised of a helical shape to allow the laterals of the primary extension to travel thereon once being formed together. Essentially, the primary extension is caused to extend and collapse by rotating the supports in the appropriate direction.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a hoist in a semi-extended position according to one exemplary embodiment of the present invention.

### DETAILED DESCRIPTION OF THE PREFERRED EMBODIMENTS

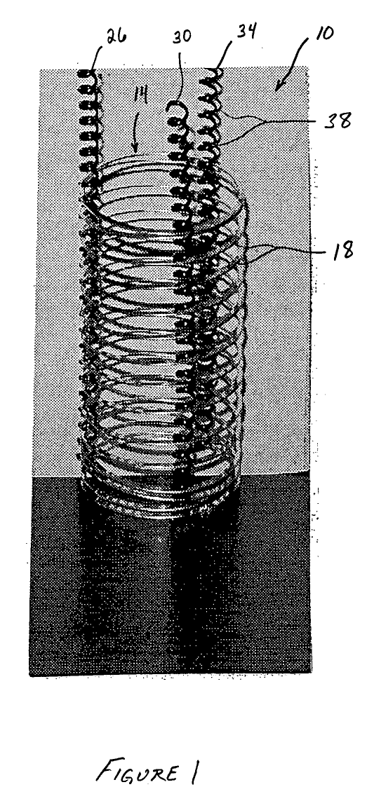

It will be readily understood that the components of the present invention, as generally described and illustrated in the figures herein, could be arranged and designed in a wide variety of different configurations. Thus, the following more detailed description of the embodiments of the system and method of the present invention, and represented in FIG. 1, is not intended to limit the scope of the invention, as claimed, but is merely representative of the presently preferred embodiments of the invention.

The presently preferred embodiments of the invention will be best understood by reference to the drawings wherein like parts are designated by like numerals throughout.

The present invention describes a method and system for hoisting an object. With reference to FIG. 1, shown is hoist 10 in a semi-extended or elevated position. Hoist 10 comprises a primary extension 14 that is circular and helical in shape, or that is formed in the shape of a helix having several coils or laterals 18. Primary extension 14, since it is a helix, comprises a plurality of laterals 18 that are essentially the helical coils making up primary extension 14. The overall circular design of hoist 10 makes it easy to manipulate as it can simply be rolled along the ground or floor area into its proper position in anticipation of being actuated. Primary extension 14 and laterals 18 are comprised of a very low spring constant in order to allow primary extension 14 to extend as needed.

Hoist 10 further comprises a series of supports, shown as supports 26, 30, and 34. Supports 26, 30, and 34 comprise a pre-determined length that dictates the height or elevation to which primary extension 14 can extend. Supports 26, 30, and 34 may be of any length, but preferably comprise a length at least as long as primary extension 14 when in a collapsed position. Supports 26, 30, and 34 are also comprised of a helical shape, but also comprise a very high spring constant so as to ensure that each of these supports remains rigid. Rigidity of supports 26, 30, and 34 is designed into hoist 10 depending upon the particular usage intended for hoist 10. As such, designing hoist 10 to comprise different rigidity factors is contemplated.

Coils 38 making up supports 26, 30, and 34 are spaced apart sufficiently so as to accommodate and receive the several laterals 18 of primary extension 14. As illustrated in FIG. 1, supports 26, 30, and 34 comprise spaces defined by their helical shape that function to receive laterals 18 therein in a successive manner.

To actuate hoist 10, supports 26, 30, and 34 are caused to rotate either manually or by some type of powering means. Any friction existing between laterals 18 and coils 38 is overcome, in addition to being able to hoist any intended objects, if so desired. By inserting or setting laterals 18 within the helical shape of supports 26, 30, and 34, primary support 14 may track and extend or collapse along these supports as intended. Indeed, to actuate hoist 10, supports 26, 30, and 34 are caused to rotate either clockwise or counterclockwise to either extend or collapse primary extension 14. By rotating supports 26, 30, and 34, laterals 18 are caused to successively track along coils 38, thus causing primary extension 14 to either extend or collapse, depending upon the direction of rotation of the supports. And, because supports 26, 30, and 34 are helical, any rotation subsequently causes any laterals 18 to move in the corresponding direction. Moreover, supports 26, 30, and 34 are fixed or stationary so that their rotation results only in extension or collapsing of primary extension 14 relative to the stationary supports, rather than supports 26, 30, and 34 moving relative to a stationary primary extension. The potential expansion of primary extension 14 far exceeds prior art designs, and allows hoist 10 to achieve any height desired, only limited by the length of associated supports 26, 30, and 34.

In another embodiment, primary extension 14 is not helical, but comprises a plurality of circular rings connected together by a connector rod. The rings are operable with the supports, and extend or collapse upon rotation of the supports.

The form or shape of laterals 18 may be any known in the art, including, but not limited to, flat, curved, slotted, I-beam, or others. The shape and form will largely depend upon the application in which hoist 10 will be utilized. Moreover, the materials used to construct hoist 10 may be of any suitable kind, including, but not limited to, metal, plastic, or a hybrid of these. Preferably, primary extension 14 is comprised of a steel gauge that allows primary extension 14 to extend along the supports as needed.

Each lateral 18 of primary extension 14 is supported by and tracks along coils 38 of supports 26, 30, and 34 at similar points so that primary extension 14 remains as horizontally stable as possible, no matter the height. As such, various braces can be inserted into hoist 10. Insertion of the bracing may be at each level, or at points where two, or more laterals were combined. Adding braces would help to create multiple units of strength. Any braces desired could be inserted individually via a motorized inserter, which could be made to track along or ride the lateral component of primary extension 14. The motorized inserter could apply bracing that is separate from lateral 18, or it could flip into place bracing which has been previously attached to lateral 18. Hoist 10 could comprise variations in bracing, which would allow the structural strength of hoist 10 to vary, depending upon the particular application for which it is intended. As such, hoist 10 can be made to accommodate or account for varying requirements. Braces can be of varying sizes or shapes, thus allowing for different effects and usefulness, also depending upon the application.

The present invention also contemplates use of other types of braces, such as bladders, hydraulic components, etc. to provide permanent or temporary support to hoist 10.

Hoist 10 further comprises one or more platforms that may be coupled to primary extension 14 to support a user or an object in an extended position. The platform may be releasably coupled. Platforms may be positioned on the top, sides, or inside of primary extension 14.

Hoist 10 may comprise various shapes and designs. As such, primary extension 14 and laterals 18 should not be restrictive in their design. For example, hoist 10 may comprise a conical shape, thus allowing a user to climb the exterior portion of hoist 10 much the same way one would climb a ladder once hoist 10 is extended. In another embodiment, laterals 18 may be segmented or jointed. Utilizing segmented or jointed laterals allows various shapes, designs, and orientations to be realized, each tailored to specific applications. Allowing for various shapes and orientations, hoist 10 may extend along any direction by following or tracking along the corresponding supports. For example, the lift of hoist 10 may be completely vertical, but it may also be offset or angled depending upon the particular design of hoist 10.

The present invention hoist is applicable in many areas and has several advantages over prior art designs. For instance, and not to be limiting in any way, hoist 10 may be used in building structures, such as commercial and residential structures, wherein various items or objects are required to be lifted and positioned prior to being installed. Other environments in which the present invention may be utilized include, tunnels for tunnel support, concrete formation and reinforcement, automotive safety applications, temporary shelters, and others.

The advantages over prior art hoists is that the extension capabilities of the present invention are superior and allow for more precise adjustment. Other advantages not specifically recited herein are intended and will be recognized by one of ordinary skill in the art.

The present invention further features a method for hoisting an object or person using the structure and system described above.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

1. A hoist comprising:
a primary extension circular in design;
at least one support member also helical in design and allowing said primary extension to extend and collapse about said support upon rotation of said support.
